(19) United States
(12) Patent Application Publication
(10) Pub. No.: US 2009/0128900 A1
(43) Pub. Date: May 21, 2009

(54) AUTOSTEREOSCOPIC DISPLAY

(75) Inventor: Armin Grasnick, Jena (DE)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Idyllic Spectrum SDN BHD

(21) Appl. No.: 11/940,473

(22) Filed: Nov. 15, 2007

(51) Int. Cl. G02B 27/22

(52) U.S. Cl. 359/462; 359/463

(57) ABSTRACT

An auto-stereoscopic display device consists of a display array with a defined pixel arrangement and a parallax-barrier arranged in front of and/or behind the display array. The parallax-barrier is comprised of structural elements distributed over a barrier surface, where a barrier texture is formed by the structural elements from a row of barrier lines extending obliquely over the barrier surface and of flat barrier lines.

The invention refers to an autostereoscopic display device pursuant to the preamble of claim 1.

Autostereoscopic display devices, in particular flat or screen displays, allow for a stereoscopic presentation of a three-dimensional object, which does not require any additional viewing aids like special spectacles and similar items.

For screen and/or flat displays with a defined arrangement of picture points—i.e. pixels and/or sub pixels—array-induced arrangements from a parallax-barrier are used which are arranged before or behind the actual display. In this regard the parallax-barrier is a simple optical system which—together with the defined pixel arrangement, e.g. a LC-display, a plasma-display, an OLED display or even a conventional cathode ray display—, imparts to a control unit, e.g. a computer, and suitably edited image data an autostereoscopic picture impression to a viewer who is seated before the display devicein the case of a parallad barrier the viewing of specified image data through a suitable arrangement of transparent and translucent, i.e. opaque section can be allowed or refused. This transparent/opaque structure forms the parallax structure of the parallax barrier and is adjusted to the display.

The allocation of the parallax structure to the relevant image data on the display depends on the position of the viewer. An autostereoscopic picture impression can only take place if at least two image data can be binocularly and stereoscopically experienced in a viewer position. This can be achieved with the parallax-barrier. It can be located either before or behind the display system. The latter design form is preferred for transparent and/or translucent display forms.

Such arrangements are characterized as “array-induced arrangements” and results from the design of the parallax-barrier—and also the entire display device—being ultimately built on the array of the individual pixles and subpixels in the display, and are determined by this array. As a result, a description of the array entails a description of the all display devices that are dependent thereon, and also on the parallax-barrier, which quasi “induces”.

Parallax-barriers were, for example, described by Jacobson and Bertiher 1896, Frederick E. Ives 1903, Estenave 1906 and Clenernce W. Kanolt 1915 primarily in connection with printing techniques and films. The currently used parallax-barriers in the display technique represent transpositions of commonly used barrier arrangements from these sectors, which can, for example, be used on flat display. S. P. Ivanof and Herbert E. Ives have already suggested in the middle of the 20^{th} century a number of improvements. An extensive “Theory of Parallax-Barrier” was published in 1952 by S. H. Kaplan, wherein all at that time available current barrier-technologies are, in essence, fully disclosed. A rather extensive description of 3D-display-technologies, including a list of literature of further publications, can be found under the Hollmann URL

http://www.dur.ac.uk/n.s.hollmann/Presentations/3dv3-0.pdf

A considerable problem with the current forms of parallax-barriers is on for once the not insignificant loss of intensity of the display. In this case, proportional to the view count on the display unit, at least ½ of the initial intensity of the display is suppressed due to the barrier structure and the exact positioning of the transparent and opaque sections on the barrier surface. In the currently used barrier systems, these correspond generally to the structure of the pixel on the array of display, which is projected on the barrier system, whereby, especially the rectangular or square pixels and sub-pixels forms, are transferred onto the barrier structure. Examples for this are the parallax barriers of Messrs. Sanyo, Sharp or 4D-Vision.

The thus produced parallax barriers consist of vertical arrangements of strips or transverse-running, stair-like arrangements from transparent and/or opaque sections, in which case—due to the angled and star-like form—overlays may appear, particularly Moiré-designs, but other interferences or diffractions may also occur, which often drastically impair the image quality.

Another disadvantage of the currently used barrier systems is that for the angular arrangement of transparent structures, in horizontal as well as in vertical direction, attention must be paid to very precise and non-rotating positioning of structures. This entails a relatively costly installation of the parallax-barrier, which cannot always be solved in a satisfactory manner.

The task is, therefore, to specify an autostereoscopic display device from a screen array with defined pixel arrangements and a parallax barrier which is located in front and behind the screen array, in which the positioning of the opaque and/or transparent barrier structures, and thereby the entire parallax barrier, can be carried out easily, realized easily and can be pre-determined and which will—because of to the installed parallax barrier—only slightly affect the quality of the image presentation

This task is solved with an autostereoscopic display device with the features of claim 1. The sub-claims contain functional and/or expedient design forms in accordance with the invention.

According to the invention the autostereoscopic display device is distinguished by having a parallax-barrier showing a totality of structural elements which are distributed across a barrier surface. On account of the structural elements a barrier texture is formed which consists of rows of smooth barrier line running skewed over a barrier texture.

According to the invention, the structural elements form a parallax barrier, basic elementary transparent or opaque basic forms, from which the barrier structures are composed. These are distributed across the barrier surface in such a way that their line-up forms a row of barrier lines running skewed across the barrier surface. Due to the design of the structural elements, the barrier lines do not run in a stair-like or zigzag manner, as is the case in conventional parallax barriers with rectangular, opaque or transparent holes or transparent sections; but the barrier lines are formed—more or less strongly—vis-à-vis lines and/or strips, which are inclined towards the vertical, without any step—or zigzag structure. As a result the interfering diffractions which are encountered in the zigzag and/or step edges are completely omitted. The barrier texture formed by these lines consists of a totality of such parallel running barrier lines, which are distributed over the entire barrier surface.

Due to the particular design of the skewed barrier elements, only one precise and distortion-free installation in horizontal direction is necessary, which considerably simplifies the positioning of the parallax barrier.

In principle the appearance of the mentioned barrier texture is determined by the position and arrangement of the individual structural elements. If the invention is advantageously designed, the position of each individual structural element is determined by a virtual raster, consisting of individual anchoring boxes, which are distributed over the barrier surface, whereby a centre of each anchoring box determines the place of the structural element on the barrier surface.

The anchoring boxes and the raster created by these forms, have two functions. For one, the form of each anchoring box indicates an enveloping limitation of each structural element. On the other hand, each anchoring box can be addressed via its centre. The raster is formed by the anchoring boxes and covers the entire barrier surface and can be scaled and distorted at random in a functional and simple manner, whereby the position and form of the structural elements are defined and determined in a suitable manner.

For this purpose the anchoring boxes are arranged on the barrier surface according to the pertinent picture allocation regulations pertaining to pixel arrangement of the display array and scaled with a correction factor that describes the geometric display and viewing parameter.

The places of the individual structural elements and course of the barrier lines and with this the design of the barrier texture, must be defined in view of the view count to be achieved for the display device and the given design of the display array, i.e. the position of the pixels and subpixels. The relevant picture allocation regulation of the individual images on the display array must be taken into consideration and transferred into the allocation regulation for the positions of the structural elements on the barrier surface. The allocation regulation thus obtained serves as basis for the positioning of the anchoring boxes of the virtual raster and, thus, also for the design of the raster itself. The scaling of the raster and also the anchoring boxes takes into consideration the geometric conditions given for a particular display, e.g. a distance between a display layer and a carrier surface for the parallax barrier, a rated distance for a viewing position and similar parameters.

In an expedient design form, the distribution of the rhomboid structural elements with a viewing count of 5 is adjusted to the following parameters: addition number of structural elements for each gap=1, addition number for structural elements per line 1, repetition number in x-direction=1, repetition number in y-direction=1.

The barrier surface is purposely designed as a transparent carrier substrate with a barrier foil that is laminated onto the carrier substrate. The barrier foil itself consists of an appropriate design of exposed film material. The barrier texture is formed as exposed dark opaque—light transparent structure.

According to the invention the display device should in the following be further explained by using samples of the operation in conjunction with figures. For the same and/or same-acting parts the same reference symbols are used. Details show:

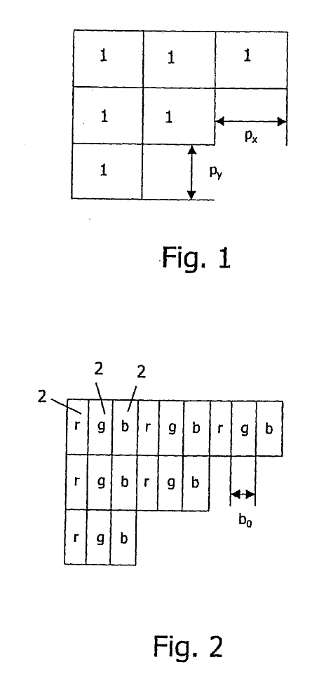

FIG. 1—A descriptive presentation for the definition of pixel width and pixel height,

FIG. 2—A descriptive presentation for defining a subpixel and the width of a subpixel

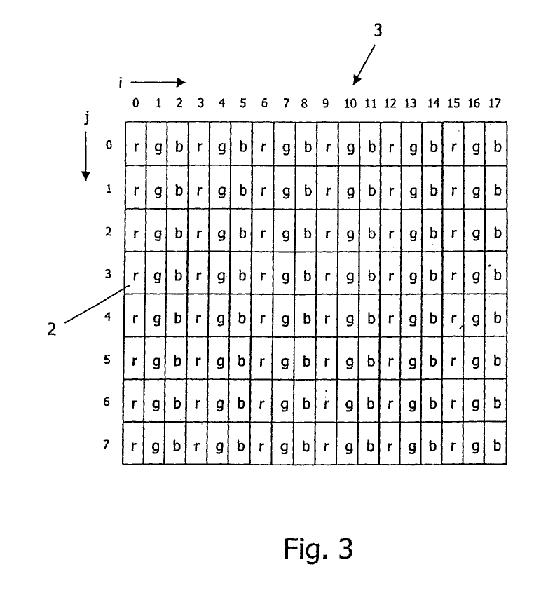

FIG. 3—A basic presentation of a display array with an indexing of subpixels contained in the array

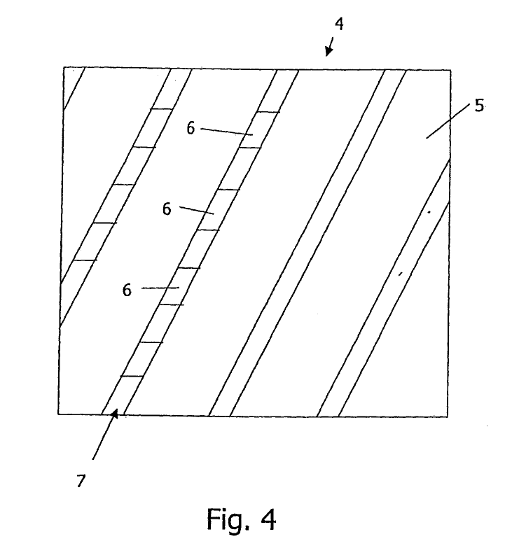

FIG. 4—An exemplary presentation of a segment of a virtual raster with anchoring boxes with barrier lines,

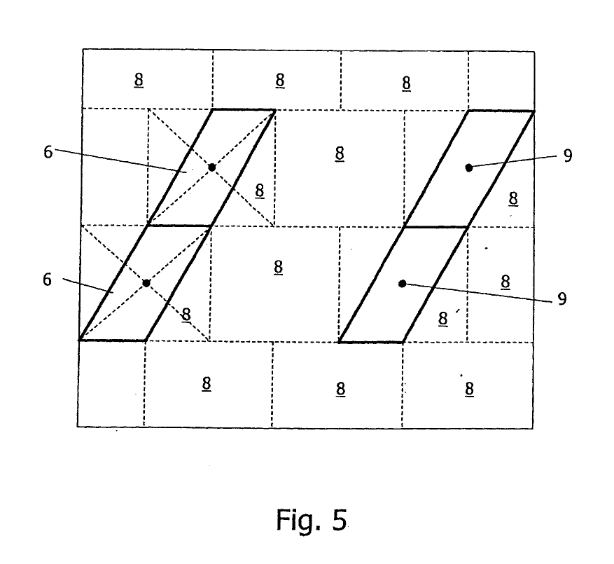

FIG. 5—An exemplary presentation of a segment of a virtual raster with anchoring boxes and samples of rhomboid structural elements which are positioned in the anchoring boxes.

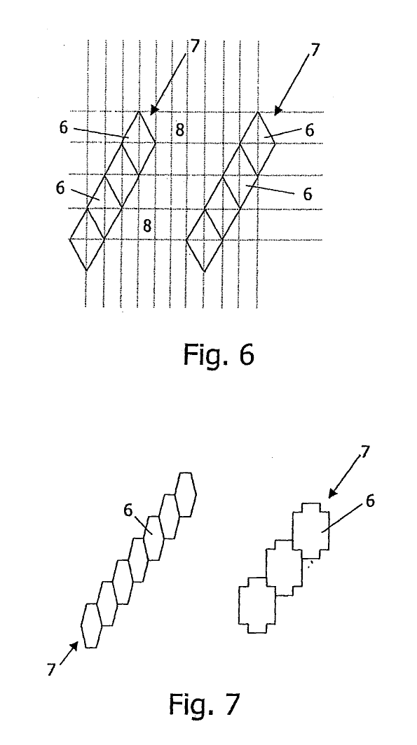

FIG. 6—An additional exemplary presentation of the virtual raster with rhomboid structural elements.

FIG. 7—Samples of hexagonal and cross-shaped structural elements.

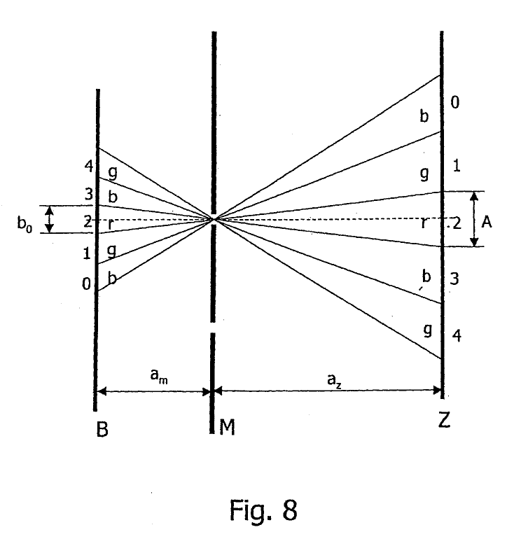

FIG. 8—A schematic presentation of geometrical conditions in the system of the display array, the parallax barrier an the viewing position

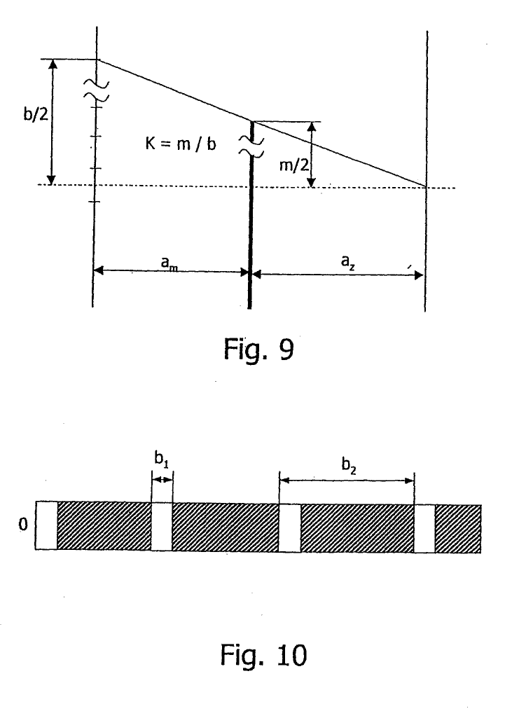

FIG. 9—A schematic presentation for the derivation of a correction factors of a barrier structure.

FIG. 10—A presentation of gap width and gap pitch of the parallax barrier.

FIG. 1 shows and explains a group of schematic pixels 1 with a horizontal pixel width pₓ and a vertical pixel height of p_{y}. In a colour display the colour value of each pixel is known to be produced by mixed colour additives. As shown in FIG. 2, each pixel is divided into 3 subpixel 2, which radiate a colour value red r, green g and or blue b in different grades of brightness. These sub pixels can be individually accessed and, thus, form the elementary raster element of the display surface. The size of these raster elements is determined by the pixel height p_{y} and by the subpixel width bₒ. The subpixel width bₒ plays a particularly important role. The subpixels can, technically speaking, be produced as elements of a LC-display, a plasma display or even as part of a conventional electron beam display.

FIG. 3 shows a segment of a display array 3 with a row of red subpixels r, green subpixels g and blue subpixels b. The position of each individual subpixel of the array is clearly defined by indexing. The sample shown here begins with horizontal numbering i at a value of i=0 and ends with i=17. A vertical numbering j of the subpixels begins in this sample at j=0 and continues until j=7. It follows that for an nₓ×n_{y} array with nₓ subpixels in horizontal and n_{y} subpixels in vertical direction, the horizontal numbering of the raster elements from i=0 until i=nₓ−1 and the vertical numbering in a corresponding manner from j=₀ until j=n_{y}−1. This index system (i; j) clearly describes the array and forms the basis for the design of the parallax barrier.

FIG. 4 shows a sample of a segment of a parallax barrier 4 in accordance with the design of the invention. The parallax barrier shows a barrier surface 5 with a barrier texture that is alternating between opaque and transparent. The individual elements of the barrier texture are composed of a row of rhomboid structural elements 6, which are grouped along skew barrier lines 7. The barrier lines and also the structural elements can be transparent or opaque. The sectors of the barrier surface located between the barrier lines possess appropriate contrasting properties. Without limiting the totality, it is assumed from the following design examples that the structural elements are translucent and arranged on an otherwise opaque barrier surface.

The parallax barrier is, for example, formed in the shape of a transparent carrier, which exhibits only negligible dispersion. For instance, a security glass or an EMV protective glass may be used for this purpose. A barrier foil is laminated on to this carrier, which is expediently formed as a black-white film, which—by using laser exposure—was provided with the relevant barrier textures. The carrier surface with the barrier foil is in the following referred to a barrier surface.

FIG. 5 shows a sample arrangement of the structural elements in conjunction with a row of anchoring boxes 8 on the barrier surface. The totality of the anchoring boxes, which are also referred to as “bounding boxes”, forms a virtual raster or lattice which are transferred on to the barrier surface, in which the structural elements are inscribed. In the example shown here, the anchoring boxes consist of rectangles in a wall-like arrangement. Their centers 9 mark their position on the barrier surface. The position is described for this purpose in an allocation regulation, which can be referred to as the allocation regulation for raster elements of the display surface, i.e. the above-mentioned indexing of subpixels and their geometric form.

The very shape of the anchoring boxes determines the form of the inscribed structural elements. According to the arrangement of the parallax barrier and the geometric conditions of use (in front and behind the display surface, the appropriate viewing distance, the size of pixel and/or subpixel, the space between the barrier surface of the display surface and the eye distance of the viewer) result in a row of corrections, in particular correction factors, with which the virtual lattice of the anchoring boxes is to be scaled. In conclusion it can be noted that the position of the structural elements is determined by the centre of the anchoring boxes, while the shape of the structural elements, i.e. their size, incline, width and form, are determined by the scaling of the anchoring boxes.

It is understood that the structural elements can show variable interior angles and that the structure of the virtual grates of the anchoring boxes can also be changed. FIG. 6 shows an example hereto. In this example the anchoring boxes form a rectangular lattice, while the structural elements are rhombus-shapes which are standing on their corners. Each corner of the rhombi shown here is described by a lattice point of the anchoring boxes and is, thus, defined by the structure of the virtual lattice. The centres of the rhombi are also determined by the virtual lattice points. It is obvious that by scaling the lattice as well as by stretching or swaging of the lattice, the shape of the rhombi and their location can be changed. By comparing the illustration in FIG. 6 with the illustration in FIG. 5 and the picture of FIG. 4 it becomes apparent that the skew barrier lines of FIG. 4 can be realized through the design form as in FIG. 5 and also through the design of the structural elements as in FIG. 6.

For this purpose rectangular, octagonal, star-shaped, elliptic or even circular structural elements can be used. 1-bit-bitmap-textures or combinations of form and bitmap-structures, like for example Fresnel structures such as zone plates, circles or spirals, can also be sued and can be used for support. Holographic objects can also be used as structural element.

With regard to the presentation in FIG. 5 it must be pointed out that the structural elements can, in principle, take on any random geometric form. When choosing the form thereby created, the purpose of the barrier structure must be taken into consideration. The presentation on the left of FIG. 7, for instance, shows an arrangement of structural elements in a hexagonal form, while presentation on the right in FIG. 7 shows structural elements in a cross form, which are purposely lined up together. The rhombus form of the structural elements as shown in FIG. 6 and/or the structural elements in the form of a rhomboid as shown in FIG. 5 appear to be most expedient with regard to the skew, smooth barrier lines shown in FIG. 4.

Moreover, it must be noted that even rectangular and/or square structural elements can be used to produce vertical barrier structures.

In the following the correction and the adjustment of the shown parallax barrier on the respective display will be explained further. FIG. 8 shows, for this purpose, a simplified presentation of the geometric proportion in a display device with parallax barrier. In the example shown here, the parallax barrier M is located between the display surface B and the viewing level Z. The subpixel illuminating the display surface are viewed through a gap S, i.e. through the transparent section of the parallax barrier. As long as the parallax barrier is placed behind the display surface and is illuminated through a light source in the rear, the conditions shown here in FIG. 8 do not change at all. The following deliberations are based on the intercept theorems, and can also be used for such a configuration and retain their validity.

FIG. 8 shows an example where the parallax barrier M is located at a distance aₘ before the display surface B. The distance aₘ is referred to as mask width. The viewing plane Z, —i.e. the plane in which the eyes of the viewer are located—is located at a distance a_{z} before the parallax barrier. This distance is called the viewing distance.

The width of an individual subpixel bₒ is projected via the gap S of the parallax barrier M on a projection width A in the viewing plane Z. For lower viewing counts the value of A is generally identical with the average eye distance of the viewer. In a display device, which should fulfill the requirement that with this a large number of views in a so-called “super multi-view condition” should be shown, the projection width takes on values, which are normally smaller than the entry pupil of the viewer's eye.

The connection between the mask width aₘ, the subpixel width bₒ, the projection width A and the viewing distance a_{z} is given through the intercept theorem with the following proportional equation:

$$\frac{{b}_{o}}{{a}_{m}} = \frac{A}{{a}_{z}}$$

If A, bₒ and a_{z} are known, the mask width is calculated through the relation

$${a}_{m} = \frac{{b}_{o} {a}_{z}}{A} \qquad ( 1 )$$

At a projection width A=65 mm, the width of the subpixels bₒ=0,181 mm and the viewing distance a_{z}=4500 mm the resulting mask widths, for example, would be aₘ=12.5 mm. One could also obtain the same value by exchanging the positions of the parallax barrier and the display surface and assuming there is an illuminated barrier.

For the design of the parallax barrier the envisioned viewing count nᵥ is of utmost importance. A single stereoscopic view is equivalent to a two-dimensional take of a picture motive from a defined position. The higher the viewing count, the more realistic is the impression of the shown stereoscopic picture that can be realized by the display device. Depending on the quality of the display device, the views are distributed on the array of the display surface by using a row of parameters. The data record that combines the different views and the information of which is displayed on the display surface, contains a row of parameters qA, qB, qX and qY, which describe the arrangement of the views in the data record. These parameters can be numerical constants, but also suitable functions, which can, for example, depend on the indices i and j.

qA indicates the addition of a view for each display gap, qB indicates the addition for each display line. The values qX and qY refer to the repeat of views in x- and/or y-direction. For example, a qA=1 and a qB=1 is an addition to a view in one gap each, while a qX=1 and/or qY=1 refers to a repeat rate of one view each in x- and/or y-direction. In order to guide data records with this parameter set on to a given display surface to a suitable impression for the viewer, it is necessary adjust the parallax barrier to these presentations. With regard to the patterns shown in FIGS. 5, 6 and 7, this means that the barrier lines, the barrier surface and also the entire virtual net from the anchoring boxes must be scaled with these defined structural elements and adjusted on to the display.

FIG. 9 shows a sample sketch for determining a correction factor for a barrier structure, which is used for the scaling of the anchoring boxes and structural elements. For the scaling it is necessary to adjust the gap width of the transparent sections of the barrier surface and the so-called gap pitch

FIG. 10 illustrates these basic barrier parameters. The gap width b₁ describes the width of a “window”, through which a pixel and/or a subpixel of the display surface can be viewed through the barrier and/or through which the pixel and/or subpixel will be illuminated. The gap pitch b₂ refer to a “lattice constant” of the barrier and is correlated with viewing count of the display device and or with the data record shown on the display surface, especially with the above mentioned parameters qA, qB, qX and qY.

The correction factor K essentially describes the centric extension of the pixel width as shown in the image geometry in FIG. 9. Under these conditions the following applies for the correction factor:

$$K = \frac{{a}_{z}}{{a}_{z} + {a}_{m}} \qquad ( 2 )$$

Together with the above-mentioned equation (1) the following applies:

$$K = \frac{{a}_{z}}{{a}_{z} + \frac{{b}_{o} {a}_{z}}{A}} = \frac{A}{A + {b}_{o}} \qquad ( 3 )$$

For example, at a value of A=65 mm and bₒ=0,181 mm the resulting value of K=0.997. The mentioned gap width and/or gap pitch is scaled with this value.

The scaled value for the gap width b₁ is arrived at by using the subpixel width b₀ and the correction factor K, taking into account

b₁=bₒK, (4)

respectively

$${b}_{1} = \frac{{Ab}_{o}}{A + {b}_{o}} \qquad ( 4 a )$$

The gap pitch b₂ is arrived at by using the viewing count n_{y} and the thus determined gap width b₁ by taking into account

b₂=b₁n_{y}, (5)

respectively

$${b}_{2} = \frac{{Ab}_{o}}{A + {b}_{o}} {n}_{v} \qquad ( 5 a )$$

For the scaling of the above described anchoring boxes reference is made to the computation of the view counts at the subpixel position with an index pair (i, j). This view count is computed as a value V, whereby the following connection exists:

$$V = {n}_{v} FractPart \frac{IntPart \frac{i}{qX} qA + IntPart \frac{i}{gY} qB}{{n}_{v}} \qquad ( 6 )$$

In this case i and j are the previously mentioned indices of the subixels on the display and qA, qB, qX and qY are the parameters for arranging the views within the data record. The connection (6) fully describes a picture screen content for an autostereoscopic display, where the picture presentation is determined by parameter sets i, j, qA, qB, qX and qY. The function FractPart refers to the uneven-number part of the expression shown within the brackets, while the function of IntPart refers to the even-number part of expression in the bracket.

For the exact computation of the position of the structural elements on the carrier surface, reference is again made to the equation (6). All—here assumed to be transparent—structural elements within the anchoring boxes on the opaque barrier surface are placed with their centers on the positions with the same view count, for example on the positions of view 0, 1, 2 etc. In that case the maximum number of index elements i and j can deviate from the number of raster elements on the, i.e. subpixel, display surface.

The absolute position of the anchoring box for each structural element is derived at by multiplying the actual value for the running index I with the width bₒ of the raster element in horizontal direction and by multiplying the actual value for the running index j with the pixel height p_{y} in vertical direction.

The concluding adjustment of the thus produced structure of the parallax barrier is arrived at by scaling the anchoring boxes and, thus, also the structural elements by using the described correction factor K. In principle, the scaling has the effect of a centric stretching of the virtual raster, at least in the direction of the horizontal or vertical.

Predominant, however, is to retain the picture ratio in respect of the horizontal direction to the vertical direction of a virtual raster.

The invented device is explained by using samples of the various style forms. It is obvious that—in the context of expert handling and taking into consideration the sub-claims—further style forms can be designed, which are not the result of the fundamental ideas of this invention.

### REFERENCE SYMBOL LIST

1. Pixel
2. Subpixel
3. Display array
4. Parallax barrier
5. Barrier surface
6. Structural element
7. Barrier line
8. Anchoring box
9. Centre

### A Projection Width

aₘ Mask width
a_{z} Viewing distance
bₒ Subpixel width
B₁ Gap width
B₂ Gap pitch
i Horizontal run index
j Vertical run index
κ Correction factor
nv View count
pv Pixel height
qA Additional number for each gap
qB Additional number for each line
qX Repetition number in x-direction
qY Repetition number in y-direction

1. Autostereoscopic display device consisting of a display array (3) with a defined pixel arrangement and a parallax-barrier (4), which is arranged before and/or behind the display array,
which is characterized by
the parallax barrier shows a totality of structural element (6) distributed over the a barrier surface (5), whereby a barrier texture is formed through the structural elements which runs skew over the barrier surface and smooth barrier lines.

2. Display device pursuant to claim 1,
which is characterized by
by the position of each individual structural element (6) being defined by virtual raster which is distributed over the carrier surface (5) and consists of individual anchoring boxes (8), whereby the centre (9) of each anchoring box describes the place of the structural elements on the barrier surface.

3. Display device pursuant to claim 2,
which is characterized by
the anchoring boxes being arranged on the barrier surface in accordance with suitable picture allocation regulation in respect of pixel arrangement of the display array and scaled with a geometric display and viewing parameter describing the correction factor.

4. Display device pursuant to claim 1,
which is characterized by
the distribution of the structural elements with a viewing count (nv) 5 being adjusted to the following arrangement parameters for the arrangement of view in a stereoscopic picture data record: additional number per gap (qA)=1, additional
number per line (qB)=1, repetition number in x-direction (qX)=1, repetition number in y—direction (qY)=1.

5. Display device pursuant to claim 1,
which is characterized by
the barrier surface being formed as a transparent carrier substrate with a laminated barrier foil.

6. Display device pursuant to claim 1,
which is characterized by
the barrier foil being formed as exposed film material, whereby the barrier texture is formed as a exposed darkish opaque/light transparent structure.
